(19) United States
(12) Patent Application Publication
(10) Pub. No.: US 2023/0324300 A1
(43) Pub. Date: Oct. 12, 2023

(54) Autofluorescence-based Biomolecular Barcode Approach for Tissue Classification

(71) Applicant: CytoVeris Inc., Farmington, CT (US)

(72) Inventors: Rishikesh Pandey, Unionville, CT (US); Alan Kersey, South Glastonbury, CT (US)

(21) Appl. No.: 18/126,117

(22) Filed: Mar. 24, 2023

Related U.S. Application Data
(60) Provisional application No. 63/323,310, filed on Mar. 24, 2022.

(51) Int. Cl. G01N 21/64

(52) U.S. Cl. CPC G01N 21/6456; G01N 21/6486

(57) ABSTRACT

A method of and a system for analyzing a tissue sample is provided. The method includes a) imaging a tissue specimen to produce multispectral images of the tissue specimen, the multispectral images including autofluorescence (AF) images and reflectance images acquired at different excitation and emission wavelengths; b) using the multispectral images to produce a plurality of biomolecular barcodes (BBCs) attributable to the tissue specimen; and c) analyzing the tissue specimen to identify a type of the tissue specimen, the analyzing using the plurality of BBCs attributable to the tissue specimen and a plurality of predetermined BBCs based on known tissue types.

This application claims priority to U.S. Patent Appln. No. 63/323,310 filed Mar. 24, 2022, which is hereby incorporated by reference in its entirety.

### BACKGROUND OF THE INVENTION

### 1. Technical Field

The present disclosure relates to devices and methods for tissue analysis in general, and the devices and methods for analyzing ex-vivo tissue specimens using autofluorescence and reflectance imaging in particular.

### 2. Background Information

For many decades the reference method for the diagnosis of cancer has been histopathological examination of tissues using conventional microscopy. This process is known as surgical pathology. In surgical pathology, samples can be produced from surgical procedures (e.g., tumor resection), diagnostic biopsies or autopsies. These samples go through a process that includes dissection, fixation, and cutting of tissue into precisely thin slices which are stained for contrast and mounted onto glass slides. The slides are examined by a pathologist under a microscope, and their interpretations of the tissue results in the pathology “read” of the sample.

Advanced optical imaging approaches have been proposed for the determination of tumor margin. These include the use of contrast-agent based fluorescence imaging [1, 2], diffuse reflectance imaging [3], Raman Spectroscopy [4, 5], hyperspectral imaging [6], optical coherence tomography [7], and autofluorescence based imaging [8, 9]. Of these imaging approaches, molecular spectroscopic techniques that do not require any exogenous dye or contrast agents and provide biomolecular-specific information are appealing particularly in an in-vivo setting. These approaches offer significant advantages to patients by avoiding potential toxicological issues, FDA approval of the contrast agents as drugs, the cost of the contrast agents, and increased surgical time associated with administering imaging agents.

The biomolecules present in different tissues provide discernible and repeatable autofluorescence [10-12] and reflectance [13] spectral patterns. The endogenous fluorescence signatures offer useful information that can be mapped to the functional, metabolic and morphological attributes of a biological specimen, and have therefore been utilized for diagnostic purposes. Biomolecular changes occurring in the cell and tissue state during pathological processes and disease progression result in alterations of the amount and distribution of endogenous fluorophores and form the basis for classification. Tissue autofluorescence has been proposed to detect various malignancies including cancer by measuring either differential intensity [14] or lifetimes of the intrinsic fluorophores [15]. Biomolecules such as tryptophan, collagen, elastin, nicotinamide adenine dinucleotide (NADH), flavin adenine dinucleotide (FAD), porphyrins, etc. present in tissue provide discernible and repeatable autofluorescence spectral patterns. While tissue autofluorescence (AF) has been proposed for cancer detection, there are at least three major limitations for conventional autofluorescence-based diagnosis approaches. First, traditional autofluorescence assays typically use a single excitation wavelength which obviously does not excite all the intrinsic fluorophores present in the tissue. Consequently, it does not effectively utilize the comprehensive and rich biomolecular information embedded in the tissue matrix both from cells and the extracellular matrix. Second, most of the applications involving AF use a fiber probe with single-point measurement capability and are inherently slow. Third, most of the multispectral AF approaches use complex artificial intelligence / machine learning (AI/ML) algorithms effectively in a “black box” and therefore lack interpretability aspect of the classification required for the surgeons and regulatory bodies.

### SUMMARY

According to an aspect of the present disclosure, a method of analyzing a tissue sample is provided. The method includes a) imaging a tissue specimen to produce multispectral images of the tissue specimen, the multispectral images including autofluorescence (AF) images and reflectance images acquired at different excitation and emission wavelengths; b) using the multispectral images to produce a plurality of biomolecular barcodes (BBCs) attributable to the tissue specimen; and c) analyzing the tissue specimen to identify a type of the tissue specimen, the analyzing using the plurality of BBCs attributable to the tissue specimen and a plurality of predetermined BBCs based on known tissue types.

In any of the aspects or embodiments described above and herein, a BBC attributable to the tissue specimen may be based on at least one ratio that includes a fluorescence intensity value determined from at least one said AF image.

In any of the aspects or embodiments described above and herein, a BBC attributable to the tissue specimen may be based on at least one ratio that includes a reflectance intensity value determined from at least one said AF image.

In any of the aspects or embodiments described above and herein, a BBC attributable to the tissue specimen may be based on at least one ratio of a first fluorescence intensity value at a first emission wavelength and a second fluorescence intensity value at a second emission wavelength.

In any of the aspects or embodiments described above and herein, the first emission wavelength may be associated with a first biomolecule and the second emission wavelength may be associated with a second biomolecule, and the first biomolecule may be different than the second biomolecule.

In any of the aspects or embodiments described above and herein, the first biomolecule may be a collagen and the second biomolecule may be a nicotinamide adenine dinucleotide (NADH).

In any of the aspects or embodiments described above and herein, the first biomolecule may be a flavin adenine dinucleotide (FAD) and the second biomolecule may be a nicotinamide adenine dinucleotide (NADH).

In any of the aspects or embodiments described above and herein, the first biomolecule may be a porphyrin and the second biomolecule may be a nicotinamide adenine dinucleotide (NADH).

In any of the aspects or embodiments described above and herein, a BBC attributable to the tissue specimen may be based on at least one ratio of a plurality of first fluorescence intensity values at a plurality of first emission wavelengths and a second fluorescence intensity value at a second emission wavelength.

In any of the aspects or embodiments described above and herein, the plurality of first fluorescence intensity values at the plurality of first emission wavelengths may be associated with a first biomolecule and a second biomolecule, and the second fluorescence intensity value at the second emission wavelength may be associated with a third biomolecule.

In any of the aspects or embodiments described above and herein, the first biomolecule may be a flavin adenine dinucleotide (FAD), the second biomolecule may be a nicotinamide adenine dinucleotide (NADH), and the third biomolecule may be a collagen.

In any of the aspects or embodiments described above and herein, the first biomolecule may be a flavin adenine dinucleotide (FAD), the second biomolecule may be a nicotinamide adenine dinucleotide (NADH), and the third biomolecule may be a tryptophan.

In any of the aspects or embodiments described above and herein, the plurality of predetermined BBCs based on known tissue types may be produced from multispectral images of a clinically significant number of empirical tissue specimens of known tissue type.

According to an aspect of the present disclosure, a system for analyzing a tissue specimen is provided. The system may include an excitation light unit, at least one photodetector, and a system controller. The excitation light unit is configured to selectively produce a plurality of excitation lights, each excitation light centered on a wavelength distinct from the centered wavelength of the other excitation lights. The at least one photodetector is configured to detect autofluorescence emissions, or diffuse reflectance signals, or both, from the tissue sample as a result of interrogation of the tissue specimen by the excitation lights, and configured to produce signals representative of the detected said autofluorescence emissions, or the detected said diffuse reflectance signals, or both. The system controller is in communication with the excitation light unit, the at least one photodetector, and a non-transitory memory storing instructions. The instructions when executed cause the system controller to a) control the excitation light unit to sequentially produce the plurality of excitation lights; b) receive and process the signals from the at least one photodetector for each sequential application of the plurality of excitation lights, and produce an image representative of the signals produced by each sequential application of the plurality of excitation lights; c) produce a plurality of biomolecular barcodes (BBCs) attributable to the tissue specimen using the images; and d) analyze the tissue specimen to identify a type of the tissue specimen, the analyzing using the plurality of BBCs attributable to the tissue specimen and a plurality of predetermined BBCs based on known tissue types.

In any of the aspects or embodiments described above and herein, a BBC attributable to the tissue specimen may be based on at least one ratio that includes a fluorescence intensity value determined from at least one AF image.

In any of the aspects or embodiments described above and herein, a BBC attributable to the tissue specimen may be based on at least one ratio that includes a reflectance intensity value determined from at least one said AF image.

In any of the aspects or embodiments described above and herein, a BBC attributable to the tissue specimen may be based on at least one ratio of a first fluorescence intensity value at a first emission wavelength and a second fluorescence intensity value at a second emission wavelength.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a flow chart illustrating a present disclosure embodiment.

FIG. 2 is a diagrammatic representation of a present disclosure system embodiment.

FIG. 3 is a table of excitation / illumination wavelengths versus reflectance / fluorescence wavelengths.

FIG. 4 is a graph of fluorescence intensity versus fluorescence emission wavelength, illustrating diagrammatic representations of biomolecule curves.

FIG. 5 is a bar chart illustrating autofluorescence intensity ratios for different biomolecules.

FIG. 6 is a bar chart illustrating log intensity ratios for different biomolecules.

FIG. 7 is a three-dimensional plot of three different intensity ratios, each assigned to an orthogonal axis, illustrating clustered data associated with different tissue types.

### DISCLOSURE OF THE INVENTION

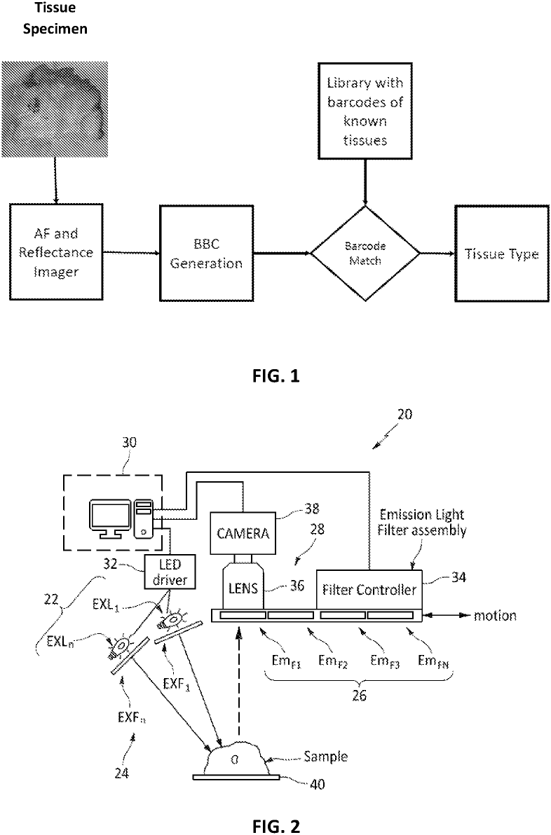

The present disclosure discloses a simplistic approach for tissue classification without necessitating any complex classifier and addresses the interpretability concerns associated with known methods and offers a potentially transformative tissue analysis tool by utilizing biomolecule and tissue microstructural information encoded in the autofluorescence and reflectance images. FIG. 1 is a flow chart illustrating a present disclosure embodiment.

Systems for producing autofluorescence (AF) and reflectance images that may be used with the present disclosure includes an excitation light unit, one or more optical filters, one or more photodetectors, and a system controller. In some embodiments, the system may include other components such as one or more of a filter controller, a tunable optical filtering device, a scanning device, an optical switch, an optical splitter, and the like.

The excitation light unit is configured to produce excitation light centered at a plurality of different wavelengths. As will be detail below, the term “excitation light unit” as used herein is not limited to a light source configured to produce AF emissions but is also able to produce reflectance signal. Examples of an acceptable excitation light source include lasers and light emitting diodes (LEDs) each centered at a different wavelength, or a tunable excitation light source configured to selectively produce light centered at respective different wavelengths, or a source of white light (e.g., flash lamps) that may be selectively filtered to produce the aforesaid excitation light centered at respective different wavelengths. The present disclosure is not limited to any particular type of excitation light unit. The wavelengths produced by the excitation light unit are typically chosen based on the photometric properties associated with one or more biomolecules of interest. The excitation light source may be configured to produce light at wavelengths in the ultraviolet (UV) region (e.g., 100-400 nm) and in some applications may include light in the visible region (e.g., 400-700 nm).

System embodiments may utilize a variety of different photodetector types configured to sense light and provide signals that may be used to measure the same. Non-limiting examples of an acceptable photodetector include those that convert light energy into an electrical signal such as photodiodes, avalanche photodiodes, a CCD array, an ICCD, a CMOS, or the like. The photodetector may take the form of a camera. As will be described below, the photodetector(s) are configured to detect AF emissions from the interrogated tissue and/or diffuse reflectance from the interrogated tissue and produce signals representative of the detected light and communicate the signals to the system controller.

The system controller is in communication with other components within the system, such as the excitation light source and one or more photodetectors. In some system embodiments, the system may also be in communication with one or more of a: filter controller, a tunable optical filtering device, an optical switch, an optical splitter, and the like as will be described below. The system controller may be in communication with these components to control and/or receive signals therefrom to perform the functions described herein. The system controller may include any type of computing device, computational circuit, processor(s), CPU, computer, or the like capable of executing a series of instructions that are stored in memory. The instructions may include an operating system, and/or executable software modules such as program files, system data, buffers, drivers, utilities, and the like. The executable instructions may apply to any functionality described herein to enable the system to accomplish the same algorithmically and/or coordination of system components. The system controller includes or is in communication with one or more memory devices. The present disclosure is not limited to any particular type of memory device, and the memory device may store instructions and/or data in a non-transitory manner. Examples of memory devices that may be used include read-only memory, random access memory, volatile memory, non-volatile memory, static memory, dynamic memory, flash memory, cache memory, and/or any device that stores digital information. The system controller may include, or may be in communication with, an input device that enables a user to enter data and/or instructions, and may include, or be in communication with, an output device configured, for example to display information (e.g., a visual display or a printer), or to transfer data, etc. Communications between the system controller and other system components may be via a hardwire connection or via a wireless connection.

Some system embodiments may include optical filtering elements configured to filter excitation light, or optical filtering elements configured to filter emitted light (including reflected light), or both. Each optical filtering element is configured to pass a defined bandpass of wavelengths associated with an excitation light source or emitted/reflected light (e.g., fluorescence or reflectance), and may take the form of a bandpass filter. In regard to filtering excitation light, the system may include an independent filtering element associated with each independent excitation light source or may include a plurality of filtering elements disposed in a movable form (e.g., a wheel or a linear array configuration) or may include a single filtering element that is operable to filter excitation light at a plurality of different wavelengths, or each excitation light source may be configured to include a filtering element, or the like. In regard to filtering emitted light, the system may include a plurality of independent filtering elements each associated with a different bandwidth or may include a plurality of filtering elements disposed in a movable form or may include a single filtering element that is operable to filter emitted/reflected light at a plurality of different wavelengths, or the like. The bandwidth of the emitted / reflected light filters are typically chosen based on the photometric properties associated with one or more biomolecules of interest. Certain biomolecules may have multiple emission or reflectance peaks. The bandwidth of the emitted / reflected light filters may be chosen to allow only emitted / reflected light from a limited portion of the biomolecule emission/reflectance response; i.e., a portion of interest that facilitates the methodology described herein. System embodiments may include a tunable bandpass filter that is controllable to provide a plurality of different bandwidth filtration modes. Some system embodiments may include an excitation filter that is disposed with, or is integrated as a part of, an excitation light source. For example, the LED or other light source can be coated with a material to allow desired bandpass.

A non-limiting example of a present disclosure system 20 is diagrammatically illustrated in FIG. 2. The system 20 includes an excitation light source 22, an excitation light filter arrangement 24, an emission/reflectance light filter assembly 26, a photodetector arrangement 28, and a system controller 30. The excitation light source 22 includes a plurality of independent excitation light sources (e.g., EXL₁... EXLₙ, where “n” is an integer greater than one), each operable to produce an excitation light centered at a particular wavelength and each centered on an excitation wavelength different from the others. The independent excitation light sources are directly or indirectly in communication with the system controller 30. In this example, the independent excitation light sources are UV LEDs. As described above, the wavelengths produced by the independent excitation light sources are chosen based on the photometric properties associated with biomolecules / tissue types of interest. The LEDs are in communication with an LED driver 32 that may be independent of the system controller 30 or the functionality of the LED driver 32 may be incorporated into the system controller 30. The excitation light filter arrangement 24 shown in FIG. 2 includes an independent bandpass filter (EXF₁...EXFₙ) for each excitation light source and the bandwidth filter properties for each independent bandpass filter are tailored for the respective excitation light source with which it is associated. In alternative embodiments, the system 20 may be configured without an excitation light filter arrangement, or each excitation light source may have an incorporated filter element, or the system 20 may include an excitation filter arrangement with a movable filter element (e.g., a wheel, linear array, etc.), or may include a single filtering element that is operable to filter excitation light at a plurality of different wavelengths. The system 20 embodiment diagrammatically shown in FIG. 2 includes an emission light filter assembly 26 having a filter controller 34 and a linear array of bandpass filters (e.g., Em_{F1}, Em_{F2} ... Em_{FN}). The filter controller 34 is configured to selectively position each respective bandpass filter in a light path between the tissue specimen (i.e., the source of the emitted /reflected light) and the photodetector arrangement 28 to permit filtering of the emitted/reflected light prior to detection by the photodetector arrangement 28. The filter controller 34 may be in communication with the system controller 30, or the filter controller 34 functionality may be incorporated into the system controller 30. As stated above, the bandwidth of the respective bandpass filters for the emitted / reflected light are typically chosen based on the photometric properties associated with one or more biomolecules of interest; e.g., to allow only emitted / reflected light from a limited portion of the biomolecule emission/reflectance response that is of interest to facilitate the analyses described herein. The photodetector arrangement 28 includes a lens arrangement 36 and a camera 38. The lens arrangement 36 is configurable to suit the application at hand. For example, in some embodiments the lens arrangement 36 may include a single fixed focus lens. In some embodiments, the lens arrangement 36 may be configured to address chromatic dispersion. For example, the lens arrangement 36 may include one or more corrective lenses configured to address aberration / focus as may be desired. In some embodiments, the lens arrangement 36 may be controllable to selectively change lens configurations and is in communication with the system controller 30. The camera 38 is configured to produce signals representative of the sensed emitted or reflected light passed through the emission light filter assembly 26. The aforesaid signals may be referred to as an “image” or may be processed into an image. The camera 38 is in communication with the system controller 30.

It should be noted that the present disclosure system embodiment diagrammatically illustrated in FIG. 2 is provided as a non-limiting illustration. System 20 embodiments may include various other system components such as additional optical filters; e.g., to limit optical interference of other scattered light, or to block excitation light from a detection path, or for other optical function, and any combination thereof.

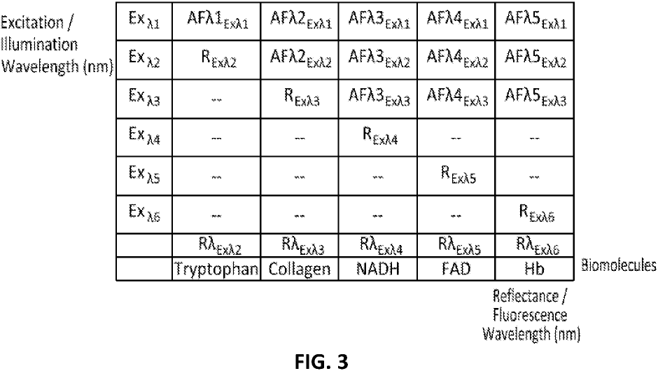

In the operation of the system 30 embodiment diagrammatically shown in FIG. 2, an excised tissue specimen may be placed on a stage 40 or other platform at a position optically aligned with the photodetector arrangement 28. In some instances, the system 20 and/or the tissue specimen may be such that the entirety of the specimen can be imaged without changing the relative positions of the tissue specimen and the system optics. In other instances, wherein the system 20 is not configured to image the entirety of the tissue specimen, the system 20 may be configured to move one or both of the tissue specimen and the system optics relative to one another so multiple regions of the tissue specimen may be imaged; e.g., the tissue specimen may be scanned. The images from the respective regions may subsequently be “stitched” together to form one or more images of the entirety of the tissue specimen. In some instances, the stage 40 may include a plurality of fiduciary markers to facilitate registration between images. The system controller 30 (through stored instructions) is configured to sequentially operate the independent excitation light sources (e.g., EXL₁... EXLₙ). As each excitation light source is operated, the produced excitation light passes through an excitation light filter prior to being incident to the tissue specimen. If a fluorophore of interest is present within the tissue specimen and that fluorophore is responsive to the wavelength of the incident excitation light, the excitation light will cause the fluorophore to produce an AF emission at a wavelength that is different from the excitation wavelength. Excitation light centered on a particular wavelength may produce AF emissions from more than one fluorophore of interest. Referring to the table in FIG. 3, a first excitation wavelength (EXλ1) can produce AF emissions at several different wavelengths (AFλ1_{EXλ1}, AFλ2_{EXλ1}, AFλ3_{EXλ1}, AFλ4_{EXλ1}, AFλ5_{EXλ1}). The same excitation light incident to the tissue specimen may also generate diffuse reflectance signals; i.e., excitation light that is reflected from the tissue specimen. For example, and again referring to the table in FIG. 3, a second excitation wavelength (EXλ2) can produce reflectance signals (R_{EXλ2}) and AF emissions at several different wavelengths (AFλ2_{EXλ2,} AFλ3_{EXλ2,} AFλ4_{EXλ2,} AFλ5_{EXλ2}), a third excitation wavelength (EXλ3) can produce reflectance signal (R_{EXλ3}) and AF emissions at several different wavelengths (AFλ3_{EXλ3}, AFλ4_{EXλ3}, AFλ5_{EXλ4}), and so on. The emission / reflectance light filter assembly 26 is controlled to coordinate placement of a particular bandpass filter in alignment with the camera 38, which bandpass filter is appropriate for the excitation light source being operated and to produce a limited bandwidth of the emitted / reflected light that is of interest for the analysis at hand; e.g., associated with particular biomolecules of interest. Some amount of the emitted light passes through the bandpass filter, is sensed by the camera 38, and the camera 38 produces signals representative of the sensed emitted/reflected light. The aforesaid signals may be referred to as an image or may be processed into an image. In some applications, an excitation wavelength may be chosen only for AF emissions of interest (e.g., EXλ1 in FIG. 3), and/or an excitation wavelength may be chosen only for diffuse reflectance signals of interest (e.g., EXλ4, EXλ5, and EXλ6 in FIG. 3). The above-described process may be repeated until the specimen has been examined using all of the desired wavelengths of excitation light. As will be detailed below, the respective images may be used to collectively identify biomolecules / tissue types of interest with a desirable degree of specificity and sensitivity. It should be noted that the number of excitation wavelengths, the number of reflectance wavelengths, the biomolecules, and the particular AF emissions selected, and reflectance emissions indicated in FIG. 3 are provided as a non-limiting example. The analysis of different types of cancer or other diseased tissue may benefit from fewer or more excitation wavelengths, different biomolecules, etc.

Excitation light incident to a biomolecule that acts as a fluorophore will cause the fluorophore to emit light at a wavelength longer than the wavelength of the excitation light; i.e., via AF. Tissue may naturally include certain fluorophores such as tryptophan, collagen, elastin, nicotinamide adenine dinucleotide (NADH), flavin adenine dinucleotide (FAD), porphyrins, and the like. Different types of diseased tissue (e.g., different types of cancerous tissue) and diseased tissue of different organs (e.g., breast tissue, liver tissue) may have different biomolecules associated therewith. The present disclosure is not therefore limited to any particular biomolecule or any particular cancer type. Biomolecular changes occurring in the cell and tissue state during pathological processes and as a result of disease progression often result in alterations of the amount and distribution of these endogenous fluorophores. Hence, diseased tissues such as cancerous tissue, due to the marked difference in cell-cycle and metabolic activity can exhibit distinct, intrinsic, and identifiable tissue AF.

Excitation wavelengths are also chosen that cause detectable light reflectance from tissue of interest. The detectable light reflectance is a function of light absorption of the tissue and/or light scattering associated with the tissue (this may be collectively referred to as diffuse reflectance). Certain tissue types or permutations thereof have differing and detectable light reflectance characteristics (“signatures”) at certain wavelengths. Significantly, these reflectance characteristics can provide information beyond intensity; e.g., information relating to cellular or microcellular structure such as cell nucleus and extracellular components. The morphology of a healthy tissue cell may be different from that of an abnormal or diseased tissue cell. Hence, the ability to gather cellular or microstructural morphological information (sometimes referred to as “texture”) provides another tool for determining tissue types and the state and characteristics of such tissue.

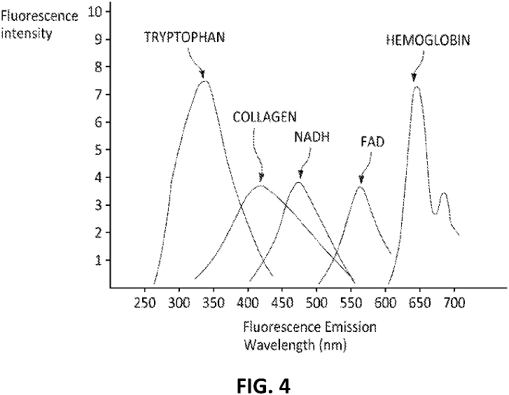

The integrated information provided by the aforesaid emitted light images provide distinct benefits in the process of identifying tissue types of interest with a desirable degree of specificity and sensitivity. As can be seen from FIG. 4, AF emissions are produced in a peaked band with an intensity value that is centered on a particular wavelength. Hence, AF emissions centered on a particular wavelength will include AF emissions not only on the peak wavelength but also on adjacent wavelengths albeit at a lesser intensity. As can also be seen in FIG. 4, biomolecules/fluorophores of interest (e.g., tryptophan, collagen, NADH, FAD, hemoglobin, etc.) have characteristic AF intensity curves with a peak centered on a wavelength but also including lesser intensities at wavelengths adjacent the peak wavelength. The AF intensity curves of some of the biomolecules may overlap to a degree. As a result, AF emissions at a particular wavelength within the overlap region may be a product of AF emissions from a first biomolecule or from a second biomolecule and are likely not dispositive by themselves of either biomolecule. As indicated above, at least some biomolecules of interest also have reflectance curves (indicating the amount of light reflectance which is a function of light absorption of the tissue and light scattering within the tissue) with a peak centered on a peak wavelength but also including lesser intensities at wavelengths adjacent the peak wavelength. The reflectance curves of some of the biomolecules may also overlap to a degree. As a result, reflectance at a particular wavelength within the overlap region may be a product of reflectance from a first biomolecule or from a second biomolecule and is likely not dispositive by itself of either biomolecule. In addition, as indicated above, reflectance images can also provide cellular or tissue microstructural information that can be used as an additional tool for determining tissue types and the state of such tissue.

The collective information provided by the aforesaid plurality of emitted/reflected light images produced by the present disclosure system 20, however, provides distinct information at different excitation wavelengths that can be used to identify biomolecule / tissue types. In some embodiments, the system controller 30 (via stored instructions) may utilize a stored empirical database during the analysis of the tissue specimen. A clinically significant number of stored AF and/or reflectance images of known tissue types (e.g., adipose, cancerous tissue, benign tissue, etc.) may be used to comparatively analyze the emitted light images (AF and/or reflectance) collected from the tissue specimen at the various different excitation wavelengths. The aforesaid analysis may utilize one or more trained algorithms, and those algorithms may apply weighing factors, or corrective factors, or the like. In some embodiments, reflectance signals /images may be used directly in a classifier and/or to correct AF images.

As a desirable alternative to an algorithmic approach as described above, the present disclosure further includes a novel identification and classification approach that utilizes biomolecular barcodes (“BBCs”) based on AF images acquired at different excitation and emission wavelengths, which BBCs are attributable to known biomolecules. The BBCs may be constructed using, for example, the intensity of the multispectral images. In some embodiments, a BBC may be multimodal containing one or more barcode types. A barcode type may include a barcode type derived from a fluorescence image (e.g., AF signal intensity at defined emission wavelengths), or a barcode type derived from reflectance images (e.g., reflectance signal intensity at defined wavelengths), or the like, or any combination thereof. In some embodiments, the reflectance images may be used to correct for the absorption and scattering characteristics in the acquired emission signal.

To identify a tissue specimen type, a BBC may be constructed and matched with the barcodes of known tissue types derived from the ground truth. A BBC may encode one or more specific molecular patterns or ratios that can be readily interpreted using minimal or no computational resources. In some instances, a barcode may be derived from a ratio of fluorescence intensity at particular wavelengths that are associated with particular biomolecules. Nonlimiting examples of such ratios include a collagen to NADH ratio, a redox ratio (FAD/NADH), an optical index ratio (porphyrins/NADH), and the like. In addition, we have discovered the following two new ratios provide great utility in the present disclosure methodology: CytoVeris ratio 1 (“CVR1”) and CytoVeris ratio 2 (“CVR2”). CVR1 may be defined as (FAD+NADH)/(Collagen) which encodes metabolites content of the cells with respect to collagen content featuring extracellular matrix (ECM) characteristics. CVR2, on the other hand, encodes primarily cellular features and may be defined as (FAD+NADH)/(Tryptophan). Classification / identification of a tissue specimen may be performed based on the similarity of one or more of these BBCs derived from that tissue specimen using BBCs derived from known tissue specimens. The BBCs derived from known tissue specimens may be stored in a memory device configured as a library or other data storage format.

FIG. 1 is a schematic diagram of an embodiment of the disclosed classification approach using BBCs. A panel of multispectral images (e.g., acquired using a TumorMAP™ multispectral imaging system produced by CytoVeris, Inc. of Farmington, Connecticut USA) may be produced using an AF and Reflectance Imager. A non-limiting example of such a system and method for producing multispectral images is described herein and also in U.S. Patent Application No. 18/027,022, entitled “Multi-Spectral Imager for UV-Excited Tissue Autofluorescence Mapping”, commonly assigned with the present application, and which is hereby incorporated in its entirety. BBCs associated with a tissue specimen may be generated / derived from multispectral images of the tissue specimen in the manner described herein; e.g., a BBC may be based on one or more ratios of fluorescence intensity or reflectance intensity at particular wavelengths that are associated with particular biomolecules. As stated above, such ratios include a collagen to NADH ratio, a redox ratio (FAD/NADH), an optical index ratio (porphyrins/NADH), a FAD+NADH)/Collagen ratio (CVR1), a FAD+NADH / Tryptophan ratio (CVR2), and the like. These BBCs may be derived using simple arithmetic operations. The BBCs derived from the tissue specimen may then be compared with predetermined BBCs derived from a clinically acceptable population of tissue specimens. The predetermined BBCs may be stored in a memory device configured as a library or other data storage format. The classification / identification of the tissue sample may be based on similarities (e.g., a “match”) between the BBCs derived from the tissue specimen and the stored predetermined BBCs. If the tissue specimen BBC or BBCs match with one or more of the stored predetermined BBCs, then the tissue specimen type may be classified / identified. If the tissue specimen BBC or BBCs do not sufficiently match with a stored predetermined BBC, then the tissue specimen may be flagged as an outlier and flagged for further analysis.

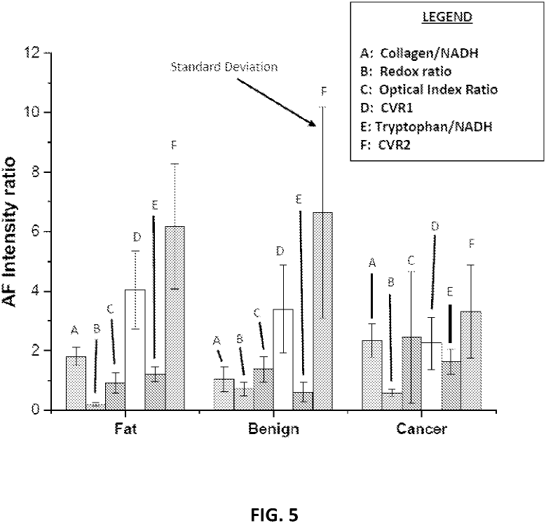

FIG. 5 is a bar graph of AF intensity ratio, depicting the average value of certain exemplary AF intensity ratios, for the aforesaid tissue types (adipose, benign, cancer) indicating that these ratios are distinct for a different tissue and therefore useful in tissue identification. Each bar in the graph of FIG. 5 also includes a line bar representative of a standard deviation value. The magnitude of the standard deviation may be attributable to the lack of an ideal ground truth; i.e., 100% homogeneity. Hence, the higher relative standard deviations may be attributable to data contribution from inhomogeneity. The AF intensity ratios shown in FIG. 5 are examples of AF intensity ratios that may be used, and the present disclosure is not limited to these particular intensity ratios.

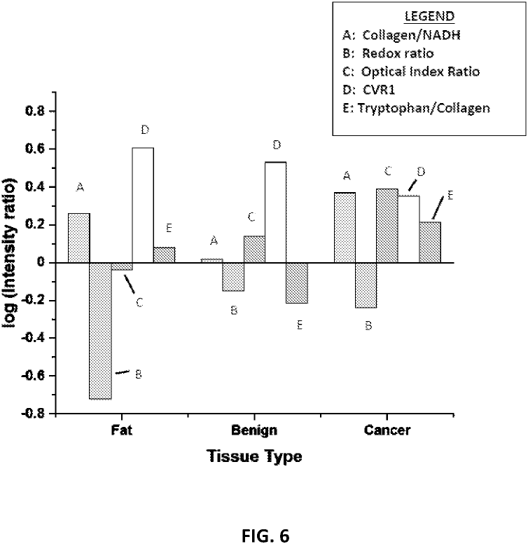

FIG. 6 is a bar graph of log intensity ratio for the aforesaid tissue types (adipose, benign, cancer), illustrating a log of the mean value of some of the ratios shown in FIG. 5. In some instances, the log values may provide an enhanced means of differentiating tissue types.

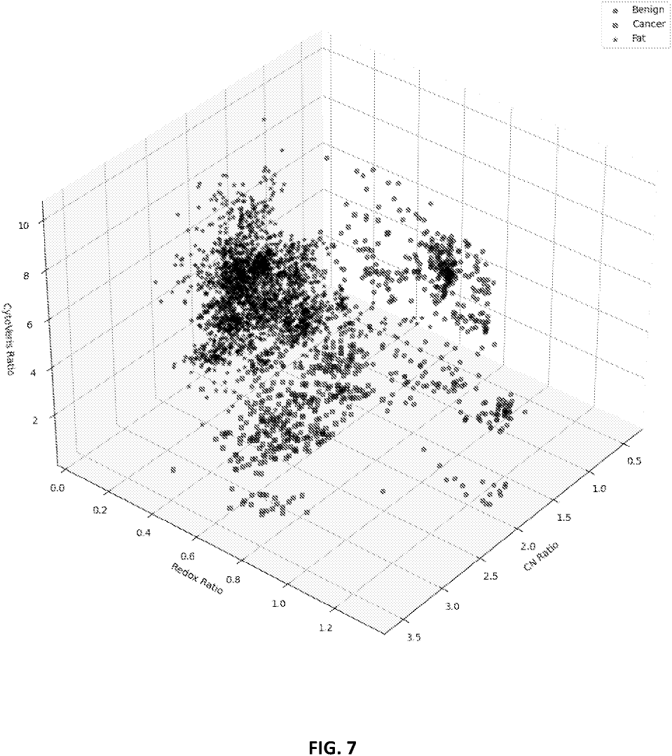

FIG. 7 is a three-dimensional cluster plot of CytoVeris ratio (CVR1 or CVR2, shown on the Z-axis), Redox ratio (FAD/NADH, shown on the X-axis), and Collagen/NADH ratio (Y-axis), illustrating the discrimination ability of different tissues based on these ratios.

The present disclosure is not limited to breast tissue and/or analyzing ex-vivo tissue specimens. Different BBCs can be generated for a variety of cancer types and/or tissue abnormalities. Additionally, the present disclosure may be used for identifying normal tissue types, for example, analyses involving identification of detrusor muscle tissue or muscularis propria in transurethral resection of bladder tumor procedure. While this disclosure mentions a device for ex-vivo analysis as a representative example, the concept and the method are equally applicable to an in vivo device including fiber-based AF and reflectance handheld or robotic probes.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details. For example, the present disclosure has been described above in terms of analyzing tissue specimens suspected to include cancerous tissue associated with, for example, breast cancer, liver cancer, bladder cancer, colon cancer, and the like. The present disclosure also provides considerable utility with procedures associated with detecting and treating the same. For example, the tissue specimen may be an ex-vivo specimen produced during intraoperative surgery, or the tissue specimen may be a tissue biopsy, or the tissue specimen may be produced and analyzed in conjunction with mammogram for a tissue biopsy diagnosis, or the tissue specimen may be used for triaging surgical specimens in a pathological setting, or the like. The aforesaid are non-limiting examples of applications of the present disclosure.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. It is further noted that various method or process steps for embodiments of the present disclosure are described herein. The description may present method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

### REFERENCES

1. Q. T. Nguyen, R. Y. Tsien, Fluorescence-guided surgery with live molecular navigation - a new cutting edge. Nature Reviews Cancer 13, 653-662 (2013).

2. Q. R. Tummers et al., Real-time intraoperative detection of breast cancer using near-infrared fluorescence imaging and Methylene Blue. Eur J Surg Oncol 40, 850-858 (2014).

3. L. L. de Boer et al., Towards the use of diffuse reflectance spectroscopy for real-time in vivo detection of breast cancer during surgery. Journal of Translational Medicine 16, 367 (2018).

4. A. S. Haka et al., Margin Assessment during Partial Mastectomy Breast Surgery Using Raman Spectroscopy. Cancer Research 66, 3317 (2006).

5. W. C. Zúñiga et al., Raman Spectroscopy for Rapid Evaluation of Surgical Margins during Breast Cancer Lumpectomy. Scientific Reports 9, 14639 (2019).

6. E. Kho et al., Hyperspectral Imaging for Resection Margin Assessment during Cancer Surgery. Clinical Cancer Research 25, 3572-3580 (2019).

7. H. Schmidt et al., Evaluation of surgically excised breast tissue microstructure using wide-field optical coherence tomography. The Breast Journal 26, 917-923 (2020).

8. J. Unger et al., Real-time diagnosis and visualization of tumor margins in excised breast specimens using fluorescence lifetime imaging and machine learning. Biomed. Opt. Express 11, 1216-1230 (2020).

9. R. Pandey et al., AI-Powered Biomolecular-Specific and Label-Free Multispectral Imaging Rapidly Detects Malignant Neoplasm in Surgically Excised Breast Tissue Specimens, Arch Pathol Lab Med, 2023, 10.5858/arpa.2022-0228-OA

10. R. A. Schwarz et al., Autofluorescence and diffuse reflectance spectroscopy of oral epithelial tissue using a depth-sensitive fiber-optic probe. Appl Opt 47, 825-834 (2008).

11. W. Zheng, W. Lau, C. Cheng, K. C. Soo, M. Olivo, Optimal excitation-emission wavelengths for autofluorescence diagnosis of bladder tumors. Int J Cancer 104, 477-481 (2003).

12. T. A. Valdez et al., Multiwavelength fluorescence otoscope for video-rate chemical imaging of middle ear pathology. Anal Chem 86, 10454-10460 (2014).

13. T. M. Bydlon, R. Nachabé, N. Ramanujam, H. J. Sterenborg, B. H. Hendriks, Chromophore based analyses of steady-state diffuse reflectance spectroscopy: current status and perspectives for clinical adoption. J Biophotonics 8, 9-24 (2015).

14. M. Wang et al., Autofluorescence Imaging and Spectroscopy of Human Lung Cancer. Applied Sciences 7, 32 (2017).

15. M. Marsden et al., Intraoperative Margin Assessment in Oral and Oropharyngeal Cancer Using Label-Free Fluorescence Lifetime Imaging and Machine Learning. IEEE Transactions on Biomedical Engineering 68, 857-868 (2021).

1. A method of analyzing a tissue sample, comprising:
imaging a tissue specimen to produce multispectral images of the tissue specimen, the multispectral images including autofluorescence (AF) images and reflectance images acquired at different excitation and emission wavelengths;
using the multispectral images to produce a plurality of biomolecular barcodes (BBCs) attributable to the tissue specimen; and
analyzing the tissue specimen to identify a type of the tissue specimen, the analyzing using the plurality of BBCs attributable to the tissue specimen and a plurality of predetermined BBCs based on known tissue types.

2. The method of claim 1, wherein a said BBC attributable to the tissue specimen is based on at least one ratio that includes a fluorescence intensity value determined from at least one said AF image.

3. The method of claim 1, wherein a said BBC attributable to the tissue specimen is based on at least one ratio that includes a reflectance intensity value determined from at least one said AF image.

4. The method of claim 1, wherein a said BBC attributable to the tissue specimen is based on at least one ratio of a first fluorescence intensity value at a first emission wavelength and a second fluorescence intensity value at a second emission wavelength.

5. The method of claim 4, wherein the first emission wavelength is associated with a first biomolecule and the second emission wavelength is associated with a second biomolecule.

6. The method of claim 5, wherein the first biomolecule is a collagen and the second biomolecule is a nicotinamide adenine dinucleotide (NADH).

7. The method of claim 5, wherein the first biomolecule is a flavin adenine dinucleotide (FAD) and the second biomolecule is a nicotinamide adenine dinucleotide (NADH).

8. The method of claim 5, wherein the first biomolecule is a porphyrin and the second biomolecule is a nicotinamide adenine dinucleotide (NADH).

9. The method of claim 1, wherein a said BBC attributable to the tissue specimen is based on at least one ratio of a plurality of first fluorescence intensity values at a plurality of first emission wavelengths and a second fluorescence intensity value at a second emission wavelength.

10. The method of claim 9, wherein the plurality of first fluorescence intensity values at said plurality of first emission wavelengths is associated with a first biomolecule and a second biomolecule, and the second fluorescence intensity value at said second emission wavelength is associated with a third biomolecule.

11. The method of claim 10, wherein the first biomolecule is a flavin adenine dinucleotide (FAD), the second biomolecule is a nicotinamide adenine dinucleotide (NADH), and the third biomolecule is a collagen.

12. The method of claim 10, wherein the first biomolecule is a flavin adenine dinucleotide (FAD), the second biomolecule is a nicotinamide adenine dinucleotide (NADH), and the third biomolecule is a tryptophan.

13. The method of claim 1, wherein the plurality of predetermined BBCs based on known tissue types are produced from multispectral images of a clinically significant number of empirical tissue specimens of known tissue type.

14. A system for analyzing a tissue specimen, comprising:
an excitation light unit configured to selectively produce a plurality of excitation lights, each said excitation light centered on a wavelength distinct from the centered wavelength of the other said excitation lights;
at least one photodetector configured to detect autofluorescence emissions, or diffuse reflectance signals, or both, from the tissue sample as a result of interrogation of the tissue specimen by the excitation lights, and configured to produce signals representative of the detected said autofluorescence emissions, or the detected said diffuse reflectance signals, or both;
a system controller in communication with the excitation light unit, the at least one photodetector, and a non-transitory memory storing instructions, which instructions when executed cause the system controller to:
control the excitation light unit to sequentially produce the plurality of excitation lights;
receive and process the signals from the at least one photodetector for each sequential application of the plurality of excitation lights, and produce an image representative of the signals produced by each sequential application of the plurality of excitation lights;
produce a plurality of biomolecular barcodes (BBCs) attributable to the tissue specimen using the images; and
analyze the tissue specimen to identify a type of the tissue specimen, the analyzing using the plurality of BBCs attributable to the tissue specimen and a plurality of predetermined BBCs based on known tissue types.

15. The system of claim 14, wherein a said BBC attributable to the tissue specimen is based on at least one ratio that includes a fluorescence intensity value determined from at least one said AF image.

16. The system of claim 14, wherein a said BBC attributable to the tissue specimen is based on at least one ratio that includes a reflectance intensity value determined from at least one said AF image.

17. The system of claim 14, wherein a said BBC attributable to the tissue specimen is based on at least one ratio of a first fluorescence intensity value at a first emission wavelength and a second fluorescence intensity value at a second emission wavelength.

18. The system of claim 17, wherein the first emission wavelength is associated with a first biomolecule and the second emission wavelength is associated with a second biomolecule.

19. The system of claim 18, wherein the first biomolecule is different than the second biomolecule.

20. The system of claim 14, wherein the plurality of predetermined BBCs based on known tissue types are produced from multispectral images of a clinically significant number of empirical tissue specimens of known tissue type.
